(19) United States
(12) Patent Application Publication
(10) Pub. No.: US 2026/0279372 A1
(43) Pub. Date: Sep. 17, 2026

(54) INFORMATION PROCESSING SYSTEM AND INFORMATION PROCESSING METHOD

(71) Applicant: YAMAHA CORPORATION, Hamamatsu-shi (JP)

(72) Inventors: Masanari NISHIMURA, Hamamatsu-shi (JP); Hiraku KAYAMA, Hamamatsu-shi (JP)

(21) Appl. No.: 19/668,971

(22) Filed: May 6, 2026

Related U.S. Application Data
(63) Continuation of application No. PCT/JP2024/038808, filed on Oct. 31, 2024.

(30) Foreign Application Priority Data
Nov. 8, 2023 (JP) 2023-190460

(51) Int. Cl. G10L 21/007; G10L 21/013

(52) U.S. Cl. CPC G10L 21/007; G10L 2021/0135

(57) ABSTRACT

An information processing system transforms a voice of a user to a voice of another person different from the user. The system includes a memory and a processor. The memory stores a program. The processor executes the program to cause a processor configured to execute a program that causes the processor to carry out accepting impression information representing an impression of the voice of another person as desired by the user. The program also causes the processor to carry out setting, from among two or more previously prepared and registered voices, one registered voice meeting the impression information, as the voice of another person.

### CROSS-REFERENCE TO RELATED APPLICATIONS

The present application is a continuation application of International Application No. PCT/JP2024/038808, filed Oct. 31, 2024, which claims priority to Japanese Patent Application No. 2023-190460, filed Nov. 8, 2023. The contents of these applications are incorporated herein by reference in their entirety.

### BACKGROUND

The present disclosure relates to an information processing system and an information processing method, for transforming a voice of a user to a voice of another person different from the user.

JP 2021-033260 A discloses processing that transforms the input voice of a user (or audio data) to the voice of another person.

### SUMMARY

However, the disclosed processing still has room for improvement in terms of usability for a user.

Given the above, an object of the present disclosure is to provide such an improvement of usability for a user.

One aspect is an information processing system for transforming a voice of a user to a voice of another person different from the user. The system includes a memory and a processor. The memory stores a program. The processor is configured to execute the program to cause the processor to carry out accepting impression information representing an impression of the voice of another person as desired by the user. The program also causes the processor to carry out setting, from among two or more previously prepared and registered voices, one registered voice meeting the impression information, as the voice of another person.

Another aspect is an information processing system for transforming a voice of a user to a voice of another person different from the user. The system includes a memory and a processor. The memory stores a program. The processor is configured to execute the program to cause the processor to carry out selecting an overlaying proportion indicating a proportion of the voice of the user as unprocessed by a voice transformation model to be laid over a version of the voice of the user as transformed into the voice of another person by the voice transformation model. The program also causes the processor to carry out producing a voice in which the voice of the user is laid over the voice of another person based on the overlaying proportion.

Another aspect is an information processing method for transforming a voice of a user to a voice of another person different from the user. The method includes accepting impression information representing an impression of the voice of another person as desired by the user. The method also includes setting, from among two or more previously prepared and registered voices, one registered voice meeting the impression information, as the voice of another person.

A more complete appreciation of the present disclosure and many of the attendant advantages thereof will be readily obtained as the same becomes better understood by reference to the following detailed description when considered in connection with the following figures, in which:

### BRIEF DESCRIPTION OF THE DRAWINGS

FIG. 1A shows a configuration of an information processing system according to an embodiment of the present disclosure;

FIG. 1B shows a configuration of an information processing system according to another embodiment of the present disclosure;

FIG. 2 is a block diagram of the hardware configuration of an information processing apparatus of the information processing system;

FIG. 3 is a block diagram of the hardware configuration of a user terminal of the information processing system;

FIG. 4 is a block diagram of the functions implemented by the information processing apparatus (or a processor of the information processing apparatus);

FIG. 5 is a block diagram of an example configuration of a voice transformation model;

FIG. 6A shows an example relationship between a tolerable amount of delay time (or a tolerable delay amount) and an overlaying proportion;

FIG. 6B shows another example relationship between a tolerable amount of delay time (or a tolerable delay amount) and an overlaying proportion;

FIG. 7 shows an example relationship between a speech intelligibility level and an overlaying proportion;

FIG. 8 shows an example of phonation onset phases within the voice of a user;

FIG. 9 is an activity diagram of the flow of a first information processing method;

FIG. 10A shows an example screen displayed on the user terminal for entering impression information;

FIG. 10B shows another example screen displayed on the user terminal for entering impression information;

FIG. 10C shows yet another example screen displayed on the user terminal for entering impression information; and

FIG. 11 is an activity diagram of the flow of a second information processing method.

### DETAILED DESCRIPTION

The present specification is applicable to an information processing system and an information processing method, for transforming a voice of a user to a voice of another person different from the user.

The present disclosure can improve user usability.

The embodiments will now be described with reference to the accompanying drawings, wherein like reference numerals designate corresponding or identical elements throughout the various drawings. The embodiments presented below serve as illustrative examples of the present disclosure and are not intended to limit the scope of the present disclosure. In the accompanying drawings referenced in the embodiments, similar reference numerals, characters, or symbols may be used to indicate corresponding or identical elements. For example, to distinguish like elements, “A” may be appended to a reference numeral and “B” may be appended to the same reference numeral.

Thus, embodiments of the present disclosure will be described with the aid of the accompanying drawings. Individual features that will be discussed in different embodiments presented below can be combined with each other.

It should be appreciated to those skilled in the art that a program providing for software in the embodiments disclosed herein may be provided in the form of a non-transitory computer-readable medium, may be downloaded from an external server, or may be run on an external computer to provide functions on a client terminal, thereby constituting so-called cloud computing.

Moreover, the term “module” used herein can encompass, for example, any combinations of hardware resources implemented by circuits as understood in a general meaning and information processing by software that can be embodied on such hardware resources. Further, a variety of information to be dealt with in the embodiments disclosed herein can be represented by, for example, the physical values of signals indicating voltage and/or current, the magnitude of signals as expressed with a set of bits in a binary system constituted by 0s and 1s, or quantum superposition of a so-called qubit, and can be communicated by or used for computation on circuits as understood in a general meaning.

By the way, the circuits as understood in a general meaning refer to circuits formed by combining at least components like a circuit, a circuitry, a processor, and/or a memory as appropriate. That is, examples of such circuits include an application-specific integrated circuit (or ASIC), a programmable logic device (or, for example, simple programmable logic device (or SPLD)), a complex programmable logic device (or CPLD), and a field programmable gate array (or FPGA)).

The description of hardware configurations follows.

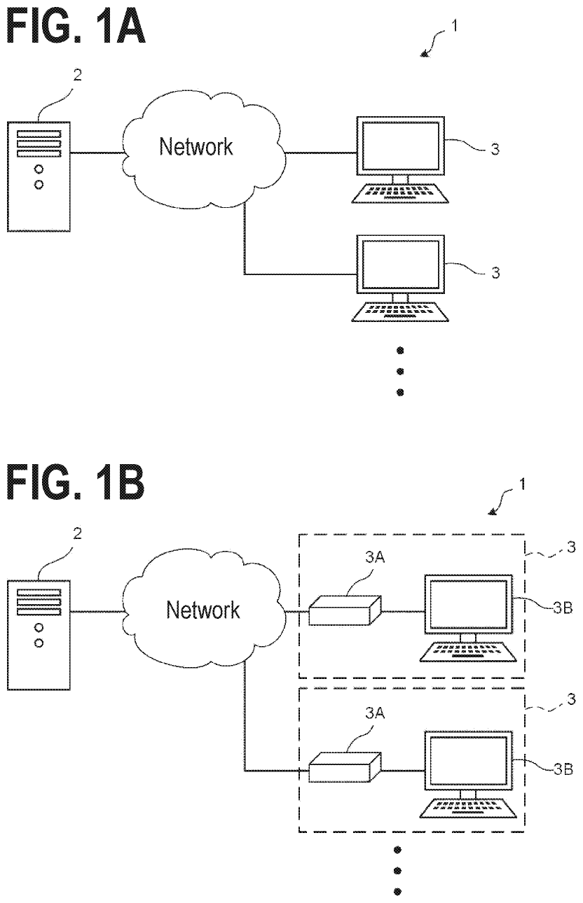

FIGS. 1A and 1B show configurations of an information processing system 1 according to embodiments of the present disclosure. The information processing system 1 includes an information processing apparatus 2 and a user terminal 3. The information processing apparatus 2 and the user terminal 3 are configured to be in communication over a telecommunication network. In some embodiments, the information processing system 1 includes at least one of such apparatus or other more components. Say, if the information processing system 1 was only formed of one or more of such apparatuses 2, the information processing system 1 would correspond to the apparatus or apparatuses 2 themselves. Now, these components will be discussed below.

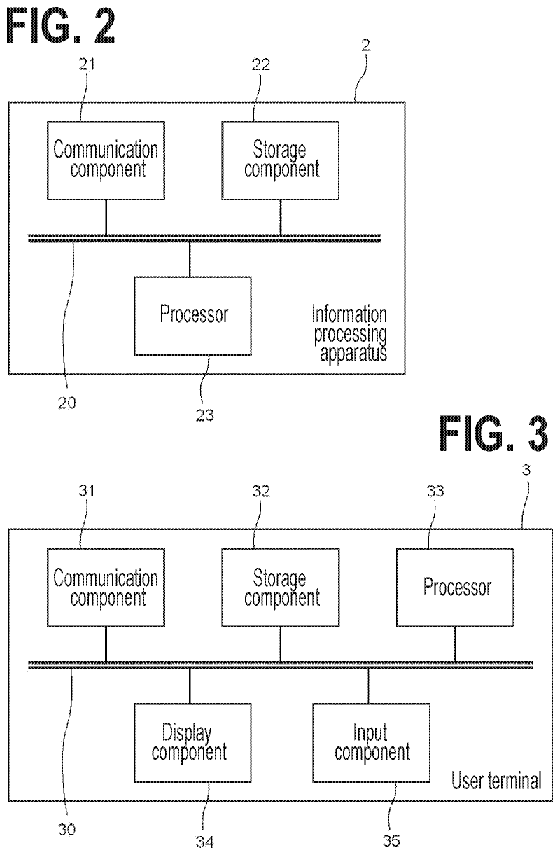

FIG. 2 is a block diagram of the hardware configuration of the information processing apparatus 2. The information processing apparatus 2 includes a communication bus 20, a communication component 21, a storage component 22, and a processor 23. The communication component 21, the storage component 22, and the processor 23 are electrically connected via the communication bus 20 within the information processing apparatus 2.

The communication component 21 may preferably be compatible with USB, IEEE1394, Thunderbolt (registered trademark), a wired LAN network communication, and/or other such wired communication protocol, but may alternatively or additionally be compatible with a wireless LAN network communication, a mobile communication protocol like 3G, LTE, and/or 5G, BLUETOOTH (registered trademark) protocol, and/or other such wired communication protocol, as necessary. That is, it is more preferred that the communication component 21 cover a set of two or more protocols from such communication protocols. As such, the information processing apparatus 2 may exchange a variety of information with an external entity via the communication component 21 over one or more networks.

The variety of information as defined above may be stored in the storage component 22. By way of example, the storage component 22 can be implemented by a storage device such as a solid-state drive (or SSD) in which are stored a variety of programs and other information concerning the information processing apparatus 2 and ready for execution by the processor 23, and/or by a memory such as a random access memory (or RAM) that stores temporarily necessary information (or, for example, arguments and arrays) related to program computations. A variety of programs, variables, and/or other more information concerning the information processing apparatus 2 and ready for execution by the processor 23 may be stored in the storage component 22.

The processor 23 is responsible for the processing and control of the general operation pertaining to the information processing apparatus 2. For example, the processor 23 includes a central processing unit (or CPU). The processor 23 loads and runs a certain program stored in the storage component 22 to implement a variety of functions pertaining to the information processing apparatus 2. That is, information processing by software stored in the storage component 22 can be embodied on the processor 23, which represents example hardware, such that the information processing is implemented as individual functional modules incorporated into the processor 23. Thus, the processor 23 is configured to execute a program that causes the processor 23 to implement the individual functional modules. These modules will be discussed later in detail. It should be apparent that a configuration with a single processor 23 is not necessarily the case and that a configuration with more than one processor 23 per function may alternatively be adopted. Further, any combination of these configurations is likewise possible.

FIG. 3 is a block diagram of the hardware configuration of the user terminal 3. The user terminal 3 includes a communication bus 30, a communication component 31, a storage component 32, a processor 33, a display component 34, and an input component 35. The communication component 31, the storage component 32, the processor 33, the display component 34, and the input component 35 are electrically connected via the communication bus 30 within the user terminal 3. The communication component 31, the storage component 32, and the processor 33 will not be discussed because the description of the corresponding components in the information processing apparatus 2 also apply here.

The display component 34 presents, on a screen, a graphical user interface (or GUI) that can be acted on by a user. The display component 34 may be an internal part of the user terminal 3 or may be externally connected to the user terminal 3. More specifically, the display component 34 may be implemented as a cathode ray tube (or CRT) display, a liquid crystal display, an organic electroluminescence (or EL) display, a plasma display, and/or other such display device. Suitably, one or more of these different display devices are chosen and deployed according to the type of the user terminal 3.

A user can make an input action through the input component 35. The input action is forwarded to the processor 33 via the communication but 30 as a command signal. The processor 33 can perform predetermined control and/or computations as needed, based on the forwarded command signal. The input component 35 may be an internal part of the user terminal 3 or may be externally connected to the user terminal 3. For example, the input component 35 may be implemented as a touch-sensitive panel that is integrated into the display component 34. When the input component 35 is implemented as a touch-sensitive panel, a user can perform tapping, swiping, and/or other more input actions on the input component 35. In addition to or in place of the touch-sensitive panel, a switch button, a mouse, a QWERTY keyboard, and/or other such device can be employed as the input component 35.

The information processing apparatus 2 may be on-premise based or cloud based. For example, a cloud-based information processing apparatus 2 can take on a software as a service (or SaaS) configuration or a cloud computing configuration to provide the aforementioned functions and processing.

The user terminal 3 can be a general-purpose computer as shown in FIG. 1A or may be formed of a combination of an audio interface 3A and a computer 3B connected to the audio interface 3A as shown in FG. 1B. That is, the information processing system 1 may include at least one of the computer 3B or the audio interface 3A. According to this configuration, the information processing system 1 can incorporate the computer 3B or the audio interface 3A as one of many constituent elements or components. The audio interface 3A may not only have the ability to receive and transmit audio data from/to the computer 3B but also have the ability to stream or, otherwise, distribute audio over a network.

The description of functional components of the embodiments disclosed herein follows. Information processing by software stored in the storage component 22 can be embodied on the processor 23, which represents example hardware, such that the information processing is implemented as individual functional modules incorporated into the processor 23. The information processing system 1 functions as a system for transforming the voice of a user to the voice of another person different from the user.

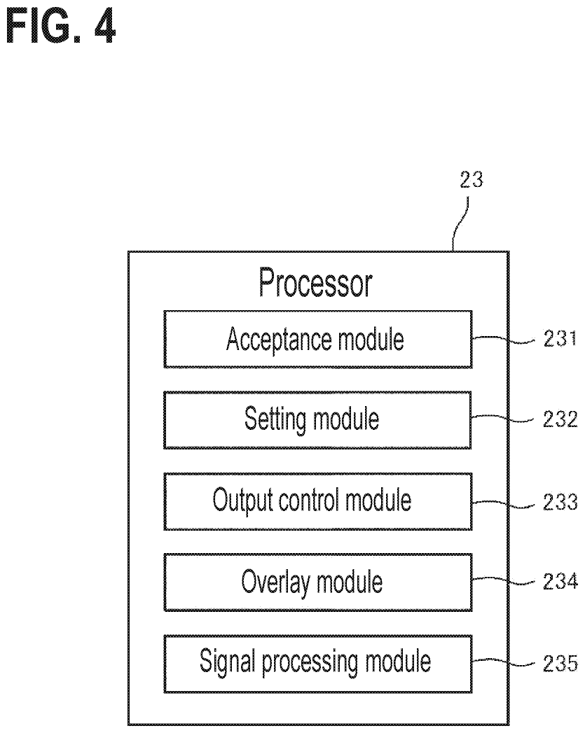

FIG. 4 is a block diagram of the functions implemented by the information processing apparatus 2 (or the processor 23 of the information processing apparatus 2). More specifically, the information processing apparatus 2 (or the processor 23 of the information processing apparatus 2) provides an acceptance module 231, a setting module 232, an output control module 233, an overlay module 234, and a signal processing module 235.

The information processing apparatus 2 is configured to implement a first transform function, a second transform function, and any combination of these functions. The first transform function provides an interface that can be used by a user to select the voice of another person. The second transform function is used to tune the output of a transformed voice. Now, the different modules of the information processing apparatus 2 in the first transform function and the second transform function will be discussed below one by one.

The first transform function mainly makes use of the acceptance module 231, the setting module 232, and the output control module 233 of FIG. 4.

The acceptance module 231 may be configured to acquire a variety of information. More specifically, the acceptance module 231 accepts impression information representing the impression of the voice of another person as desired by a user and the voice of the user as entered through the user terminal 3. For example, the impression information is entered using the input component 35 of the user terminal 3 via a user interface (or UI) visually presented on the user terminal 3. For example, the voice of the user is entered using a microphone that the user terminal 3 has (or a microphone connected to the user terminal 3).

The “impression information” is not quantitative information represented by a numerical value and/or other such parameter, but qualitative information represented by a word or sentence-namely, natural language—that approximates the impression of a voice that a user wants his or her voice to be transformed into. Examples of the impression information include “gentle”, “cute”, “handsome”, “mature”, “clear voice”, “tense voice”, and any other words that can be used to modify the impression of a voice. For instance, the impression information can be formed of a combination of more than one word like “gentle” and “handsome”, or a sentence containing more than one word like “ . . . is a gentle tall person”.

For impression information formed of a combination of more than one word or a sentence containing more than one word, the acceptance module 231 may present a first list of options (or two or more candidate words from which a selection can be made) to a user to prompt the user to select a word and successively present a next list of such options to the user to prompt the user to select a word, and can repeat this process to acquire more than one selected word as elements of the impression information. In this configuration, the acceptance module 231 may choose what words to be included in the next list of options, based on what word was selected from a previous list of options. For example, in response to selection of the word “gentle” from the first list of options, the acceptance module 231 may present a next list of options formed of words indicating the degree of the word “gentle” or a next list of options formed of words that may be potentially used in combination with (or may have collocation with) the word “gentle”.

Additionally or alternatively, the impression information may be formed of a combination of a word representing an impression and the degree of the impression. For example, such impression information can be in the form of “cute: 5” or “cute: 5 and handsome: 3”. The numerical value assigned to the word indicates the magnitude of the impression represented by the word. For example, a user can enter the magnitude of the impression by using a slide bar or other such UI element on the user terminal 3.

Additionally or alternatively, the acceptance module 231 may present a UI including a free text area on the user terminal 3 to accept any sentence entered by a user (or, for example, “ . . . is a gentle tall person”). The acceptance module 231 may accept the sentence entered by the user, as part of the impression information. In this configuration, an upper limit may be defined on the number of letters that can be entered, in order to avoid accepting too many words.

Additionally or alternatively, the acceptance module 231 may accept specification information specifying the voice of another person and different from the impression information. For example, the acceptance module 231 may accept speaker information (corresponding to an example of the specification information) entered in place of the impression information. The speaker information is information used to directly specify one of registered voices that will be further discussed later. Thus, the speaker information may contain one or more numerals or numerical values (or a combination of symbols, such as alphabets, that can be converted into one or more numerals or numerical values) used to specify one registered voice that a user wishes. In order to accept the entered speaker information, the acceptance module 231 may present mutually exclusive UI elements (or, for example, radio buttons) to allow the speaker information to be selected.

Additionally or alternatively, the acceptance module 231 may accept a pitch of the voice of the user. For example, the acceptance module 231 accepts the voice of the user entered through the user terminal 3 and has a F0 (or fundamental frequency) estimator to acquire a pitch (or fundamental frequency) of the voice of the user from the voice of the user. To acquire a pitch from the voice of the user in this way, the acceptance module 231 may present to the user a text previously prepared for pitch acquisition purposes and prompt the user to read out the text to record the uttered voice. Additionally or alternatively, the acceptance module 231 may accept a numerical value indicating the pitch as entered (or specified) by the user.

The setting module 232 can be configured to set, from among two or more previously prepared and registered voices, one registered voice meeting the impression information, as the voice of another person. In this configuration, the voice of a user can be transformed into a voice that approximates the image (or impression) held by the user. Accordingly, a user can intuitively select one registered voice.

The “registered voice(s)” used in this context mean one or more recorded voices, for which reference information (or, for example, a trained voice transformation model that will be further discussed later) that can be used by the output control module 233, which will be further discussed later, to transform the voice of a user into the voice of another person in real time is recorded in the information processing system 1 (or, more specifically, the storage component 22). Each of the two or more registered voices has an identifier (or identification label). Each of the registered voices may be assigned with more than one identifier—for example, an identifier for impression information and an identifier for speaker information—to allow the one registered voice to be set based on the impression information and/or the information (or, for example, the speaker information) different from the impression information. Additionally or alternatively, a pitch (or average pitch) may be set for each of the two or more registered voices.

The setting module 232 may set, as the voice of another person, one registered voice assigned with an identifier that is identical or substantially identical to numerical information derived from the impression information. In this configuration, identifiers can be used to facilitate the registration and management of registered voices. When there is a registered voice with an identifier that is identical to numerical information derived from the impression information, the acceptance module 232 can set this registered voice as the voice of another person. Meanwhile, when there is no registered voice with an identifier that is identical to numerical information derived from the impression information, the setting module 232 may set, as the voice of another person, one registered voice with an identifier that is the closest to the numerical information among the identifiers of the registered voices. It should be recognized that the registered voice identifiers being considered in this context are those for impression information.

For example, as a way to derive the numerical information to be matched against the identifiers of the registered voices, the impression information may be vectorized-namely, mapped into a vector space-through natural language processing by the serring module 232 to acquire the numerical information. In this configuration, a registered voice that approximates the image held by a user can be picked based on the entered qualitative impression information. More specifically, the setting module 232 may feed a word or sentence contained in the impression information to a vectorizer (or, typically, a classifier with a trained model) that relies on a TF-IDF method, an LSI method, an LDA method, Word2vec, BERT, and/or other such algorithm to produce a corresponding vector.

For impression information that is formed of a combination of words, the setting module 232 may feed each of the words to the vectorizer to utilize the result of a computation (or, for example, summation) using the vectors of the words as the numerical information derived from the impression information. For impression information that is formed of a sentence, the setting module 232 may feed the sentence to a vectorizer configured to vectorize a sentence to use the vectorized result of the sentence as the numerical information derived from the impression information. It should be apparent that, in case of per-word vectorization, a given word is always converted to the same vector as long as the same vectorizer is used. Meanwhile, in case of vectorization of sentences, a given word can be converted to different vectors depending on the context, even when the same vectorizer is used.

Additionally or alternatively, for impression information formed of a sentence, the setting module 232 may use a morphological analysis engine such as, for example, MeCab to segment the sentence into one or more words. In so doing, those letters that cannot be extracted as words are excluded from the vectorization. The setting module 232 may feed each of the segmented words to the vectorizer to utilize the result of a computation using the vectors of the words as the numerical information derived from the impression information.

For example, as another way to derive the numerical information to be matched against the identifiers of the registered voices, the setting module 232 may assign a numerical value in advance to a word that the user may enter so that the numerical information can be derived with the aid of such numerical values. More specifically, the setting module 232 may assign, say, “cute” and “mature” that could be in the impression information with respective vectors {1, 0, 0, 0} and {0, 1, 0, 0} in advance. In this configuration, without subjecting the impression information to natural language processing-namely, without using the vectorizer—the setting module 232 may refer to a table describing the relationship between words that could be contained in the impression information and corresponding vectors (or a table in which the words and the vectors are associated with each other on a one-to-one basis) to acquire the numerical information. It should be noted that, for impression information containing more than one word, the result of a computation (or, for example, summation) using the vectors of these words may be utilized as the numerical information derived from the impression information, as in the natural language processing scenario.

Additionally or alternatively, the setting module 232 may set, as the voice of another person, one registered voice with an identifier that is identical or substantially identical to the specification information (or, for example, the speaker information) different from the impression information. Thus, the setting module 232 can not only set the one registered voice based on the impression information but also set the one registered voice based on the speaker information. In this configuration, a user can be provided with various ways to specify a voice into which the voice of the user is to be transformed. That is, a user can not only enter impression information to set the one registered voice but also enter speaker information to directly specify the one registered voice. It should be recognized that the registered voice identifiers being referred to in this context are those for speaker information.

Additionally or alternatively, the setting module 232 may refer to reference information stored in the storage component 22 to convert the impression information to the speaker information and set the one registered voice based on the speaker information. In this configuration, the speaker information converted from the impression information corresponds to the “numerical information derived from the impression information”, and the speaker information can be matched against identifiers for speaker information to set the one registered voice.

For example, a first information conversion model that has been trained through machine learning to learn correlations between the impression information and the speaker information is used to provide such reference information used to convert the impression information to the speaker information. The first information conversion model can be a model that has been trained with machine learning to use the impression information and acoustic data (or input voice) as input to produce the speaker information as output. The first information conversion model is trained with supervised data in which combinations of impression information and acoustic data are labeled with corresponding speaker information. The setting module 232 may feed the impression information and voice of a user as accepted by the acceptance module 231 to the first information conversion model and set, as the voice of another person, one registered voice with an identifier that is identical or substantial identical to the speaker information produced by the first information conversion model. Additionally or alternatively, the reference information used to convert the impression information to the speaker information may be, in particular, a table describing the relationship between the impression information and the speaker information, and/or a conversion formula for converting the numerical information derived from the impression information to the speaker information.

Additionally or alternatively, the setting module 232 may refer to the reference information to convert the speaker information to the impression information. For example, a second information conversion model that has been trained through machine learning to learn correlations between the speaker information and the impression information is used to provide such reference information used to convert the speaker information to the impression information. The second information conversion model can be a model that has been trained with machine learning to use the speaker information and acoustic data (or input voice) as input to produce the impression information as output. The second information conversion model is trained with supervised data in which combinations of speaker information and acoustic data are labelled with corresponding impression information. The setting module 232 may feed the speaker information and voice of a user as accepted by the acceptance module 231 to the second information conversion model as input and use the impression information produced by the second information conversion model as output to set the one registered voice.

Additionally or alternatively, the setting module 232 may set, from among the two or more registered voices, one registered voice meeting the impression information and the pitch of the voice of the user, as the voice of another person. In this configuration, the voice of a user can be transformed into the voice of another person that is adapted to the pitch of the voice of the user. For example, the setting module 232 may modify the fundamental frequency of the one registered voice meeting the impression information, according to the pitch of the voice of a user. More specifically, the setting module 232 may instruct the output control module 233 to feed a pitch modification amount to a voice transformation model as one variable, so that the one registered voice with a tuned pitch can be set, as will be further discussed later.

The output control module 233 may be configured to cause a variety of audio including the voice of a user to be output from a speaker and/or other such output device. More specifically, the output control module 233 may feed the voice of the user and the identifier of the one registered voice that is set as the voice of another person to the voice transformation model and produce a version of the voice of the user as transformed into the one registered voice from the voice transformation model. The voice transformation model can include a model that is trained through machine learning to learn a per-identifier relationship between a fed voice and a registered voice. In this configuration, an input voice can be correctly transformed into the voice of another person based on the impression information from the user. For example, the output control module 233 causes the audio to be output by a speaker or other such audio output device that the user terminal 3 has (or is connected to the user terminal 3) or an audio output device that is connected to the user terminal 3 over a network.

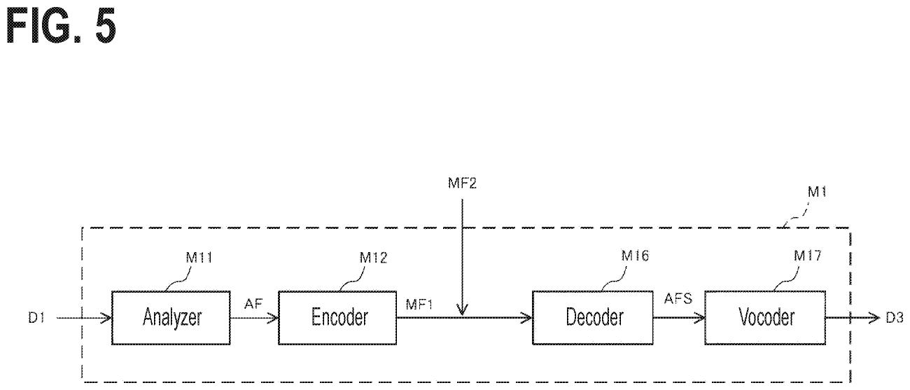

For example, the voice transformation model is stored in the storage component 22. The voice transformation model can be a model that has been trained through machine learning in advance. FIG. 5 is a block diagram of an example configuration of the voice transformation model M1. The voice transformation model M1 receives acoustic data D1 as input and produces synthetic acoustic data D3 as output. The voice transformation model M1 includes an analyzer M11, an encoder M12, a decoder M16, and a vocoder M17.

The acoustic data D1 contain, in particular, waveform data on a voice (that can encompass vocal performance) and/or waveform data on sound from a musical instrument. The voice of a user as entered through the user terminal 3 can be fed to serve as the acoustic data D1 to the voice transformation model M1. The synthetic acoustic data D3 are waveform data on a version of the acoustic data D1 (or the voice of the user) as transformed into the one registered voice (or the voice of another person) that has been specified.

The analyzer M11 may subject the voice of the user (or acoustic data D1) to frequency analysis to convert the voice of the user to acoustic feature data AF and acquire the fundamental frequency (or pitch) of the voice of the user. The acoustic feature data AF represent the frequency spectrum of the sound represented by the acoustic data D1. For example, the frequency spectrum is a mel-scale log spectrum (or MSLS).

The encoder M12 may be a trained model that is configured to use the data (or acoustic feature data AF) on the voice of the user as input to produce a first intermediate feature MF1 as output. The first intermediate feature MF1 represents intermediate data that are used by the decoder M16 to produce synthetic acoustic feature data AFS. The method to train the encoder M12 will be further discussed later.

The decoder M16 may be a trained model that is configured to receive the first intermediate feature MF1 as input to produce data (or the synthetic acoustic feature data AFS) on a version of the voice of the user as transformed into the one registered voice, as output. The synthetic acoustic feature data AFS represent a frequency spectrum that is generated based on the intermediate feature. For example, the frequency spectrum is a mel-scale log spectrum.

The decoder M16 may receive a second intermediate feature MF2 as input. That is, the decoder M16 may be configured to receive the second intermediate feature MF2 in addition to or as an alternative to the first intermediate feature MF1 as input to produce the synthetic acoustic feature data AFS as output. The second intermediate feature MF2 can be any information including, for example, data in the form of numerical information generated by an encoder different from the encoder M12 through vectorization of a feature and/or linguistic information used by the encoder M16 to produce the synthetic acoustic feature data AFS as output.

The vocoder M17 may generate the synthetic acoustic data D3 based on the synthetic acoustic feature data AFS produced by the decoder M16. More specifically, the vocoder M17 may use the synthetic acoustic feature data AFS to reconstruct acoustic signals to generate the synthetic acoustic data D3.

A machine learning device can be used to train each of the encoder M12 and the decoder M16 for the training of the voice transformation model M1. The machine learning device may be incorporated into the information processing system 1 (or, for example, may be part of the information processing apparatus 2), or may be an external entity to the information processing system 1. Examples of the training method that can be used include a convolutional neural network (or CNN), a recurrent neural network (or RNN), and any combination of these networks. Examples of the model that can be used for training include an autoregressive model and an attention-based model.

The training may be done for each of the identifiers of the registered voices. Firstly, for each of the identifiers of the registered voices, a plurality of supervised datasets in which acoustic data for training purposes are associated with synthetic acoustic feature data serving as labels for training purposes may be stored in the machine learning device. The acoustic data for training purposes contained in the supervised datasets can include the voices (that can encompass vocal performance) of original utterers of the registered voices (or the persons who orally provided the registered voices). Further, the amount of the acoustic data for training purposes to be used in a single training step can correspond to a certain number of frames for a frequency analysis. This training step may be repeated until all frames in the supervised datasets are considered.

Once the supervised datasets are prepared, the machine learning device may use the analyzer M11 to generate the acoustic feature data AF from the acoustic data for training purposes. Secondly, the machine learning device may feed the acoustic feature data AF to the encoder M12 being trained as input, so that the encoder M12 generates the first intermediate feature MF1.

The machine learning device may feed the first intermediate feature MF1 generated by the encoder M12, together with an identifier of a registered voice, to the encoder M16 being trained as input, so that the encoder M16 generates the synthetic acoustic feature data AFS. The machine learning device trains the encoder M12 and the decoder M16 such that the synthetic acoustic feature data AFS produced by the decoder M16 comes closer to the synthetic acoustic feature data for training purposes.

More specifically, the machine learning device can perform backpropagation to update variables constituting the encoder M12 and variables constituting the decoder M16 such that the errors between the synthetic acoustic feature data AFS generated by the decoder M16 and the synthetic acoustic feature data for training purposes included in the supervised datasets are reduced. Such a training step can be repeated until a voice transformation model M1 associated with an identifier of a registered voice, namely, one voice provider, is obtained. That is, a voice transformation model M1 is obtained which, in response to the specification of an identifier of a registered voice, can synthesize a voice having the sound quality of a registered voice associated with that identifier.

In addition, the machine learning device may use the acoustic data for training purposes employed in the training to set a pitch for the voice transformation model. More specifically, the average frequency of the acoustic data for training purposes with outliers excluded can be stored as the pitch for the voice transformation model, together with a corresponding identifier and other information.

After the basic training mentioned above, the machine learning device may further subject the decoder M16 to supplementary training. In this supplementary training, the decoder M16 is the only component to be trained within the voice transformation model M1. The supplementary training can be done for each of the identifiers of the registered voices. During the supplementary training, firstly, a plurality of supervised datasets in which acoustic data for training purposes are associated with synthetic acoustic feature data serving as labels for training purposes may be stored in the machine learning device. The amount of the acoustic data for training purposes to be used in a single training step can correspond to a certain number of frames for a frequency analysis. This training step may be repeated until all frames in the supervised datasets are considered.

Once the supervised datasets are prepared, the machine learning device may use the analyzer M11 to generate the acoustic feature data AF from the acoustic data for training purposes. Secondly, the machine learning device may feed the acoustic feature data AF to the encoder M12 that has been trained as input, so that the encoder M12 generates the first intermediate feature MF1. Then, the machine learning device may feed the first intermediate feature MF1 generated by the encoder M12 to the encoder M16 being trained as input, so that the encoder M16 generates the synthetic acoustic feature data AFS.

The machine learning device may train the decoder M16 such that the synthetic acoustic feature data AFS produced by the decoder M16 comes closer to the synthetic acoustic feature data for training purposes. In this way, the decoder M16 can be subjected to the supplementary training that serves as additional training in which the acoustic feature data are used as sole input.

Each voice transformation model M1 that has been trained may be assigned with the identifier of a corresponding registered voice (or, for example, an identifier for impression information and/or an identifier for speaker information). Such a voice transformation model M1 at least includes a decoder M16 labeled with the identifier of a corresponding registered voice-namely, a decoder M16 that is trained in association with the identifier of a corresponding registered voice.

The encoder M12 included in the voice transformation model M1 may be trained in association with the identifier of a corresponding registered voice or may be trained without any association with the identifier of a corresponding registered voice. When in association with the identifier of a corresponding registered voice, the encoder M12 serves as an encoder exclusive to the identifier of a corresponding registered voice and can only be used in combination with the decoder M16 for the same identifier. Meanwhile, when not in association with the identifier of a corresponding registered voice, the encoder M12 serves as a universal encoder that has been trained for two or more registered voices with different identifiers (or for a plurality of encoders M16).

As mentioned earlier, not only the supervised datasets but also an identifier of a registered voice can be used as input during the training of the voice transformation model M1. In so doing, two or more types of identifier (or, for example, an identifier for impression information and an identifier for speaker information) assigned to the same registered voice may be randomly chosen and fed as input to train the voice transformation model M1. In this way, a voice transformation model M1 linked with two or more types of identifier can be obtained.

When encoders M12 are labeled with registered voice identifiers, the output control module 233 may select an encoder M12 that receives the voice of a user as input and a decoder M16 that receives an intermediate feature as input, based on the identifier of a registered voice of interest. In this configuration, based on impression information entered by a user, an encoder M12 and a decoder M16 can each be selected from among all those encoders and decoders that are prepared for different registered voices, thereby achieving an improved precision with which to transform the voice of a user into the voice of another person.

The machine learning device may subject the encoder M12 to supplementary encoder training. In this supplementary encoder training, the encoder M12 is the only component to be trained within the voice transformation model M1. The supplementary encoder training may likewise be done for each of the identifiers of the registered voices. Similarly to the supplementary training for the decoder M16, the supplementary encoder training may use supervised datasets in which acoustic data for training purposes are associated with synthetic acoustic feature data serving as labels for training purposes.

Once the supervised datasets are prepared, the machine learning device may use the analyzer M11 to generate the acoustic feature data AF from the acoustic data for training purposes. Secondly, the machine learning device may feed the acoustic feature data AF to the encoder M12 being trained as input, so that the encoder M12 generates the first intermediate feature MF1. Then, the machine learning device may feed the first intermediate feature MF1 generated by the encoder M12 to the encoder M16 that has been trained as input, so that the encoder M16 generates the synthetic acoustic feature data AFS. The machine learning device trains the encoder M12 such that the synthetic acoustic feature data AFS produced by the decoder M16 comes closer to the synthetic acoustic feature data for training purposes.

The output control module 233 may use the difference (of, for example, 120 Hz) between the pitch (at, for example, 440 Hz) of a user as accepted by the acceptance module 231 and the pitch (at, for example, 680 Hz) of one registered voice having a specified identifier as a pitch modification amount to feed the same as an input to the voice transformation model M1. The voice transformation model M1 may produce, as output, synthetic acoustic data D3 with a fundamental frequency corresponding to the sum of the fundamental frequency of the input acoustic data D1 (or the voice of the user) and the pitch modification amount.

The second transform function mainly makes use of the overlay module 234 and the signal processing module 235 in addition to the acceptance module 231, the setting module 232, and the output control module 233 of FIG. 4. The second transform function requires that the voice of another person (or the one registered voice) into which the voice of the user is to be transformed have been set. The one registered voice may be set by the first transform function that has been discussed above or may be set by a process or mechanism different from the first transform function.

As in the first transform function, the acceptance module 231 may accept specification information specifying the voice of another person as desired by a user and the pitch of the voice of the user. The “specifying information” for the second transform function can include the impression information and/or information (or, for example, the speaker information) different from the impression information. The pitch of the voice of the user may be accepted in the same way that is discussed in connection with the first transform function.

For the second transform function, the acceptance module 231 may accept from the user terminal 3 the input of a tolerable amount of delay time of a voice to be produced by the output control module 233 (or a version of the voice of the user as transformed into the voice of another person) relative to input of the voice of the user. The “delay time” means the time lag between the input of the voice of a user to the information processing system 1 and the output of a version of the voice of the user as transformed into the voice of another person by the output audio device under the control of the output control module 233.

The acceptance module 231 may accept the tolerable amount of delay time, as a selected numerical value (or, for example, a selected time from the range of 20 to 100 ms) or as a label (or option) indicating the degree of the tolerable amount, including, for example, “long”, “medium”, and “short”.

Additionally or alternatively, for the second transform function, the acceptance module 231 may accept from the user terminal 3 the input of a speech intelligibility level for the voice of another person. The “speech intelligibility level” refers to the degree of improvement of the accent of the voice of another person, at a phonation onset phase of the voice of another person.

The acceptance module 231 may accept the speech intelligibility level as a selected position of a knob on a slider. The speech intelligibility level may be accepted as a label (or option) indicating the degree of the speech intelligibility level. including, for example, “good”, “fair”, and “poor”.

The tolerable amount of delay time and the speech intelligibility level serve as parameters that are used to select an overlaying proportion that will be further discussed below. Additionally or alternatively, the acceptance module 231 may accept the overlaying proportion as entered. That is, the acceptance module 231 may directly accept the overlaying proportion, without the use of the tolerable level of delay time.

As in the first transform function, the setting module 232 may set, from among the two or more previously prepared and registered voices, one registered voice meeting the specification information and the pitch of the voice of the user, as the voice of another person. In this configuration, the second transform function can also transform the voice of a user into the voice of another person that is adapted to the pitch of the user.

The overlay module 234 may be configured to select an overlaying proportion indicating a proportion of the voice of the user as unprocessed by the voice transformation model M1 to be laid over a version of the voice of the user as transformed into the voice of another person by the voice transformation model M1. That is, the overlay module 234 selects the percentage (or overlaying proportion) for a second voice (or the voice of the user or a processed voice of the user) that has not gone through the transform processing by the voice transformation model M1 and therefore has little delay, to be concurrently output together with a first voice (or a version of the voice of the user as transformed into the voice of another person) that has gone through the transform processing by the voice transformation model M1 and therefore has a certain large output delay. For example, when the overlaying proportion is 50%, the first and the second voices will be output at a ratio of 1:1. Further, when the overlaying proportion is 0%, only the first voice will be output. Furthermore, when the overlaying proportion is 100%, only the second voice will be output, thereby replacing the first voice with the second voice.

The overlay module 234 may provide a first overlaying function, which is used to alleviate the delay of output audio due to the processing time at the voice transformation model, and a second overlaying function, which is used to make phonemes in the output audio clearer.

For the first overlaying function, the overlay module 234 may select the overlaying proportion based on the tolerable amount of delay time as entered by the user (or as accepted by the acceptance module 231). In this configuration, the overlaying proportion can be set according to the tolerable amount of delay that a user prefers. More specifically, the overlay module 234 increases the overlaying proportion as the tolerable amount of delay time entered by a user decreases. That is, the overlay module 234 increases the overlaying proportion so that there is a greater proportion of the second voice, when the tolerable amount of delay time is low—namely, when the delay time that can be tolerated is short— and decreases the overlaying proportion so that there is a greater proportion of the first voice, when the tolerable amount of delay time is high-namely, when the delay time that can be tolerated is long. In this configuration, the proportion of a version of the voice of a user as transformed by the voice transformation model can be adjusted according to the tolerable amount.

The overlay module 234 can convert the tolerable amount of delay time to the overlaying proportion, based on a previously prepared assessment formula. The assessment formula can include a function for linear or nonlinear conversion of the tolerable amount to the overlaying proportion and/or a conditional formula that ascertains a different value of the overlaying proportion for each different range of the tolerable amount. For example, the conditional formula gives 100% overlaying proportion when the tolerable amount is between 20 ms and less than 30 ms and 50% overlaying proportion when the tolerable amount is between 30 ms and 70 ms, inclusive. Additionally or alternatively, when the acceptance module 231 accepts a label (that can include, for example, “long”, “medium”, and “short”) as the tolerable amount, the overlay module 234 may use a table describing overlaying proportions for different labels to select the overlaying proportion.

Examples of the second voice that has not gone through the transform processing by the voice transformation model M1 include the voice of the user (hereinafter referred to as a “raw voice”) and a version of the raw voice as processed by the signal processing module 235 (hereinafter referred to as a “processed voice”). When the raw voice is to be laid over the first voice, the overlay module 234 may select, as the overlaying proportion, the proportion of the voice of the user (or the raw voice) to be laid over the voice of another person (or the first voice). Also, when the processed voice is to be laid over the first voice, the overlay module 234 may select, as the overlaying proportion, the proportion of a converted voice of the user as produced by signal processing (or the processed voice) to be laid over the voice of another person (or the first voice).

For example, the acceptance module 231 accepts from the user terminal 3 the input indicating which of the raw voice and the processed voice should be used as the second voice for overlaying purposes. The relationship between the overlaying proportion and the tolerable amount of delay time for when the processed voice is used as the second voice may be different from the relationship between the overlaying proportion and the tolerable amount of delay time for when the raw voice is used as the second voice.

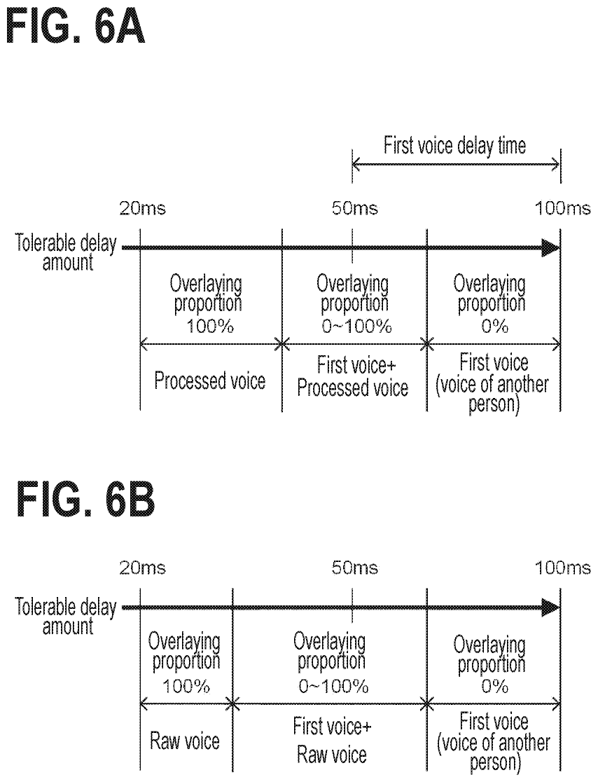

FIGS. 6A and 6B show example relationships between the tolerable amount of delay time (or the tolerable delay amount) and the overlaying proportion. In FIG. 6A showing an example of the overlaying proportion for when the processed voice is used as the second voice, three different stages of the overlaying proportion are defined as a function of the tolerable delay amount, including, in the descending order of the tolerable delay amount, a first stage in which the overlaying proportion is set to 0% (or the first voice only), a second stage in which the overlaying proportion is set to a value between 0% and 100% (or a cross-face between the first voice and the processed voice), and a third stage in which the overlaying proportion is set to 100% (or the processed voice only). For example, in the second stage, the overlaying proportion increases linearly as the tolerable delay amount decreases. It should be noted that the upper limit for the tolerable delay amount is set to the maximum possible delay time of the first voice (of, for example, 100 ms) and that the lower limit for the tolerable delay amount is set to the minimum possible delay time of the second voice (or the processed voice) (of, for example, 20 ms). Further, the minimum possible delay time of the first voice is, for example, 50 ms, with a corresponding tolerable delay amount situated in the second stage.

In FIG. 6B showing an example of the overlaying proportion for when the raw voice is used as the second voice, three different stages of the overlaying proportion are likewise defined as in the example for when the processed voice is used. Note, however, that, when the raw voice is used, the extent of the third stage (with the raw voice only) may be narrower than that of the third stage for when the processed voice is used—namely, the upper boundary may be set to a lower value. In other words, when the raw voice is used, the extent of the second stage (with a cross-fade) may be wider than that of the second stage for when the processed voice is used—namely, the lower boundary may be set to a lower value.

The overlay module 234 may have both the raw voice and the processed voice laid over the first voice. In this configuration, the overlay module 234 may select, in addition to the overlaying proportion of the second voice on the first voice, the proportions of the raw voice and the processed voice in the second voice. That is, as the second overlaying proportion, the overlay module 234 may select both an overlaying proportion (or raw voice overlaying proportion) indicating the proportion of the raw voice to be laid over the first voice and an overlaying proportion (or processed voice overlaying proportion) indicating the proportion of the processed voice to be laid over the first voice. It should be apparent that the maximum of the sum of the raw voice overlaying proportion and the processed voice overlaying proportion is 100%. The raw voice overlaying proportion and the processed voice overlaying proportion may each be entered through the user terminal 3. Additionally or alternatively, the overlay module 234 may select the raw voice overlaying proportion and the processed voice overlaying proportion as a function of the tolerable amount of delay time.

For the second overlaying function, the overlay module 234 may select the overlaying proportion in such a way that the voice of the user as unprocessed by the voice transformation model (or the second voice) is laid over the voice of another person (or the first voice), at a phonation onset phase of the input voice of the user. In this configuration, phonemes in a transformed version of the voice of a user at a phonation onset phase can be made clearer. More specifically, the overlay module 234 may select the overlaying proportion in such a way that the converted voice of the user from the signal processing (or the processed voice) is laid over the voice of another person (or the first voice), at a phonation onset phase of the voice of the user. Alternatively, the overlay module 234 may select the overlaying proportion in such a way that the raw voice is laid over the first voice, at a phonation onset phase of the voice of the user. Yet alternatively, the overlay module 234 may have both the raw voice and the processed voice laid over the first voice, at a phonation onset phase of the voice of the user.

Additionally or alternatively, the overlay module 234 may select the overlaying proportion based on the speech intelligibility level entered by a user (or accepted by the acceptance module 231). In this configuration, the overlaying proportion can be set according to the speech intelligibility level that a user prefers. More specifically, the overlay module 234 may increases the overlaying proportion as the speech intelligibility level entered by a user rises (or improves). That is, the overlay module 234 increases the overlaying proportion so that there is a greater proportion of the second voice, when the speech intelligibility level rises-namely, when a clearer speech is intended- and decreases the overlaying proportion so that there is a greater proportion of the first voice, when the speech intelligibility level drops-namely, when a clearer speech is not intended. In this configuration, the proportion of a version of the voice of a user as transformed by the voice transformation model can be adjusted according to the speech intelligibility level.

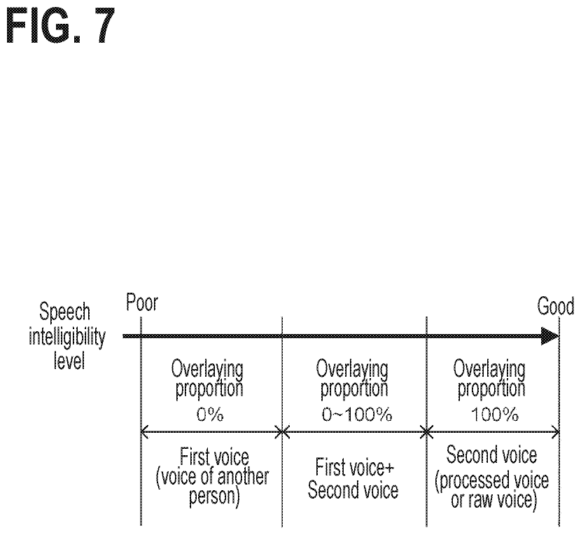

FIG. 7 shows an example relationship between the speech intelligibility level and the overlaying proportion. In the example of FIG. 7, three different stages of the overlaying proportion are defined as a function of the speech intelligibility level, including, in the descending order of the speech intelligibility level, a first stage in which the overlaying proportion is set to 0% (or the first voice only), a second stage in which the overlaying proportion is set to a value between 0% and 100% (or a cross-face between the first voice and the second voice), and a third stage in which the overlaying proportion is set to 100% (or the second voice only). For example, in the second stage, the overlaying proportion increases linearly as the speech intelligibility level improves.

The overlay module 234 may determine the moment when the speech content in the input voice of the user switches from silence to utterance, as the starting point of a “phonation onset phase”. The overlay module 234 may treat a range corresponding to a predefined number of units of time from the starting point, as a “phonation onset phase” for which the overlay processing is to be performed on the first voice.

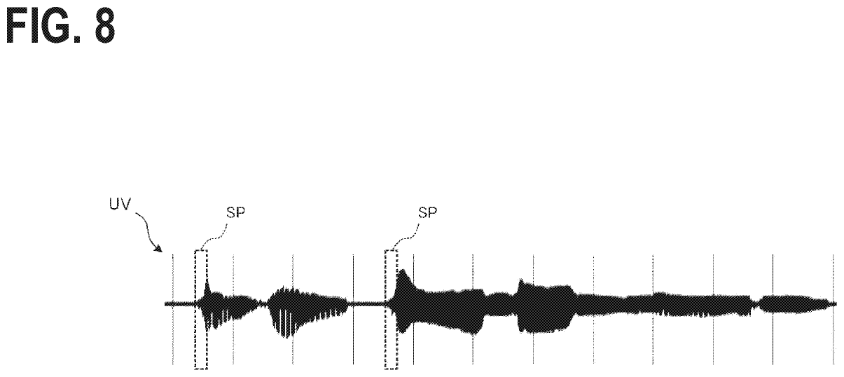

FIG. 8 shows an example of phonation onset phases SP within the voice UV of a user. For example, the overlay module 234 applies voice activity detection (or VAD) to the voice UV of the user to determine the phonation onset phases SP. Preferably, the VAD algorithm can determine the phonation onset phases SP, within the duration of transform processing for the voice UV of the user by the voice transformation model. Preferred examples of the VAD algorithm include volume-based VAD. Additionally or alternatively, the overlay module 234 may use the result that is output by the F0 estimator in response to the input of the voice UV of the user to extract silent sections and utterance sections to determine the phonation onset phases SP. The overlay module 234 may extract the phonation onset phases SP for which the overlaying of the second voice (or the processed voice and/or the raw voice) is to be performed, while in parallel the output control module 233 transforms the voice UV of the user using the voice transformation model.

The second overlaying function (or the overlaying at a phonation onset phase SP) may be performed by default using a predetermined overlaying proportion during transformation of the voice of the user, or may be enabled or disabled according to a user's selection (or setting of the overlaying proportion).

The signal processing module 235 may subject an input voice of the user to signal processing that produces the processed voice. Examples of the signal processing performed by the signal processing module 235 include pitch shift, formant transformation, and any other well-known waveform processing techniques (or algorithms) used for voice quality alteration. Only pitch shift or a combination of pitch shift and formant transformation may be applied to provide the processed voice to be laid over (or replace) the first voice.

The signal processing module 235 may subject the voice of the user to the signal processing such that the processed voice approximates the first voice as much as possible. For example, the signal processing module 235 may use a table in which parameters of the signal processing are associated with registered voices to perform such signal processing that the processed voice approximates the one registered voice selected by a user.

For the second transform function, the output control module 233 may cause a voice in which the voice of the user (or the second voice) is laid over the voice of another person (or the first voice) based on the overlaying proportion selected by the overlay module 234 to be output from the user terminal 3 and/or other device. In this configuration, the delay of output audio due to the processing time at the voice transformation model can be alleviated, and phonemes in the output audio can be made clearer.

The output control module 233 may receive from the overlay module 234 a composite waveform in which the second voice is laid over the first voice by the overlay module 234 based on the overlaying proportion and cause the composite waveform to be output from the user terminal 3 and/or other device. Additionally or alternatively, the output control module 233 may receive from the overlay module 234 the overlaying proportion selected by the overlay module 234, generate a composite waveform in which the second voice is laid over the first voice based on the overlaying proportion, and cause the composite waveform to be output from the user terminal 3 and/or other device.

What follows is a more specific procedure for having the second voice laid over the first voice as implemented by the overlay module 234 and/or the output control module 233. When the overlaying proportion is 0%—namely, when the second voice is not laid over the first voice—the output control module 233 may cause only the first voice to be output. In so doing, the first voice may be output with a delay corresponding to the sum (between, for example, 50 ms and 100 ms) of: the time required by the user terminal 3 for data conversion and data transmission and reception; the time taken to conduct the transform processing by the voice transformation model; and the time taken to carry out transmission to the audio output device. Moreover, when the overlaying proportion is 100%—namely, when the second voice replaces the first voice—the output control module 233 may cause only the second voice to be output. In so doing, the second voice may be output with a delay (of, for example, 20 ms) corresponding to the above delay time for the first voice minus the time taken to conduct the transform processing by the voice transformation model.

When the overlaying proportion has a value between more than 0% and less than 100%, the output control module 233 may have the first and second voice delayed with a delay corresponding to the tolerable amount of delay time as entered by a user and have the second voice laid over the first voice at the overlaying proportion, and cause the resultant to be output. In case that the tolerable amount is less than the actual delay time of the first voice—for example, when the tolerable amount of delay time is 40 ms whereas the actual delay time of the first voice is 60 ms—the output control module 233 may have the second voice output with a delay corresponding to the tolerable amount (of 40 ms) and have the first voice output with the actual delay time (of 60 ms). Hence, in this case, the output of the first voice is delayed relative to the output of the second voice.

For the first overlaying function of the overlay module 234, the output control module 233 may cause a voice in which the converted voice of the user from the signal processing (or the processed voice) is laid over the voice of another person (or the first voice) based on the overlaying proportion to be output. Additionally or alternatively, the output control module 233 may cause a voice in which the voice of the user (or the raw voice) is laid over the voice of another person (or the first voice) based on the overlaying proportion to be output. In these configurations, the voice of a user can be transformed while minimizing possible delay of output audio that is fed back to the user.

Additionally or alternatively, the output control module 233 may cause the voice in which the voice of the user is laid over the voice of another person to be output from the user terminal 3 and/or other device, in a manner perceivable to a user. In this configuration, audio can be fed back to a user with a minimal delay. Hence, output audio will sound less awkward to a user who can be a speaker or singer during streaming, at a concert, and/or in other such event. It should be noted that the voice in which the voice of the user is laid over the voice of another person may be output in a manner that a user, who provided the input voice, can only hear the resulting voice and audiences or viewers cannot hear the resulting voice. Thus, the output control module 233 may feed the voice in which the voice of the user is laid over the voice of another person only to the user terminal 3 used by the user who provided the original input, not to an audio output device at a streaming recipient or at a venue. Alternatively, the output control module 233 may feed the voice in which the voice of the user is laid over the voice of another person to the user terminal 3 used by the user who provided the original input and to an audio output device at a streaming recipient or at a venue. A user may set where to feed the voice in which the voice of the user is laid over the voice of another person, as desired, through the user terminal 3.

For the second overlaying function of the overlay module 234, the output control module 233 may produce a voice in which the converted voice of the user from the signal processing (or the processed voice) is laid over the voice of another person (or the first voice) at a phonation onset phase of the voice of another person. Additionally or alternatively, the output control module 233 may produce a voice in which the voice of the user (or the raw voice) is laid over the voice of another person (or the first voice) at a phonation onset phase of the voice of another person. In these configurations, a segment with such an overlay will sound less awkward, and phonemes in a transformed version of the voice of a user at a phonation onset phase can be made clearer at the same time. That is, while a voice that has been transformed tends to have an accent (obfuscation) at a phonation onset phase due to the prioritization of processing speeds, the overlaying of the second voice can counteract such an accent.

For the second overlaying function of the overlay module 234, the output control module 233 may perform the overlaying of the second voice at a phonation onset phase in the following ways. Firstly, the output control module 233 may decompose each of the first and second voices into sinusoidal waves and a noise model based on, for example, spectral modeling synthesis (or SMS). Next, the output control module 233 may add the envelope for the sinusoidal waves (or harmonic envelope) at a phonation onset phase of the second voice to the envelope for the sinusoidal waves at a phonation onset phase of the first voice, or have the envelope for the sinusoidal waves at a phonation onset phase of the first voice replaced with the envelope for the sinusoidal waves at a phonation onset phase of the second voice.

What follows is a description of information processing methods using the information processing apparatus 2. The components of the information processing apparatus 2 can be computer-implemented as different steps of the information processing methods.

A first information processing method for performing the first transform function includes an acceptance step, a setting step, and a producing step. The acceptance step involves accepting impression information representing the impression of the voice of another person as desired by a user. The setting step involves setting, from among two or more previously prepared and registered voices, one registered voice meeting the impression information, as the voice of another person. The producing step involves feeding the voice of the user and an identifier of the one registered voice that is set as the voice of another person to a voice transformation model and producing a version of the voice of the user as transformed into the one registered voice from the voice transformation model.

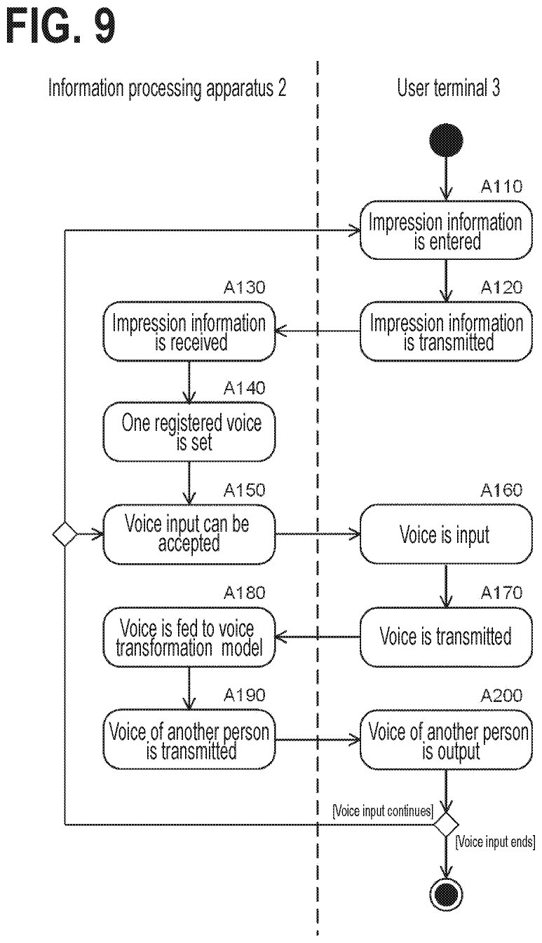

FIG. 9 is an activity diagram of the flow of the first information processing method. The first information processing method will be described below along the activities in the activity diagram.

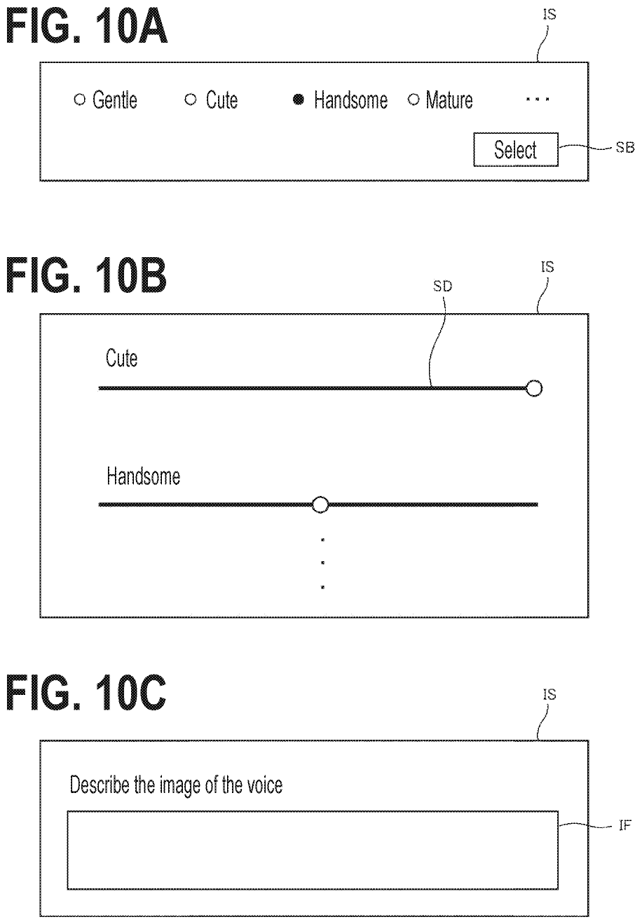

Firstly, the impression information representing the voice of another person into which the voice of a user is to be transformed is entered through the user terminal 3 (at activity A110). FIGS. 10A to 10C show example screens IS displayed on the user terminal 3 for entering the impression information. For example, referring to FIG. 10A, the information processing apparatus 2 may display a screen IS for presenting mutually alternative radio buttons to choose a word that will form the impression information. A select button SB on the screen IS can be hit to have the chosen word accepted as part of the impression information. The entering of the impression information on the screen IS and the presentation of a next list of options in the information processing apparatus 2 may be repeated to accept the input of more than one word that will form the impression information. Additionally or alternatively, referring to FIG. 10B, the information processing apparatus 2 may employ a slider SD arranged on a screen IS to accept the input of the degree of a word. Additionally or alternatively, referring to FIG. 10C, the information processing apparatus 2 may display a screen IS for presenting a free text area IF on the user terminal 3 to accept the input of a sentence that will form the impression information.

The user terminal 3 may transmit the entered impression information to the information processing apparatus 2 (at activity A120). The information processing apparatus 2 may receive the impression information from the user terminal 3 (at activity A130). Subsequently, the information processing apparatus 2 may set the one registered voice based on the entered impression information (at activity A140).

After the setting of the one registered voice, the information processing apparatus 2 may accept from the user terminal 3 the input of the voice of the user (at activity A150). Once the information processing apparatus 2 becomes ready to accept the input of the voice, the voice of the user may be entered through the user terminal 3 (at activity A160). The user terminal 3 may transmit the entered voice to the information processing apparatus 2 as needed (at activity A170). The information processing apparatus 2 may feed the voice of the user transmitted from the user terminal 3 to a voice transformation model associated with the one registered voice that has been set (at activity A180). Further, the information processing apparatus 2 may transmit the voice of another person that is produced from the voice transformation model to the user terminal 3 (at activity A190). The user terminal 3 may receive the voice of another person from the information processing apparatus 2 and cause the same to be output as audio (at activity A200).

The information processing apparatus 2 may repeat the activities between the acceptance of the voice input (at activity A150) and the transmission of the voice of another person (at activity A190), as long as the user continues to enter the voice.

Additionally or alternatively, for example, when the voice entered through the user terminal 3 is vocal performance, the information processing apparatus 2 may accept the input of the impression information and/or speaker information during the vocal performance of the user. In response to the input of the impression information and/or speaker information during the vocal performance of the user, a different registered voice can be immediately set as the one registered voice in the setting of the one registered voice at activity A140, thereby causing the voice of another person being output from the user terminal 3 to change to a different voice in real time. For example, a scenario in which a “clear voice” is entered as part of the impression information at the start of the vocal performance is considered. In response to the singing of one phrase by the user, the voice of another person meeting the “clear voice” is caused to be output for this one phrase. If a “tense voice” is entered as part of the impression information at the end of the singing of the one phrase by the user, the voice of another person will change to that meeting the “tense voice” from the next phrase on. Thus, during vocal performance, the voice of another person being output can change to a different voice in near real time in response to the input of the impression information and/or speaker information.

A second information processing method for performing the second transform function includes an acceptance step, an overlaying step, and a producing step. The acceptance step involves accepting a speech intelligibility level and/or a tolerable amount of delay time of the voice to be produced by the producing step relative to input of the voice of the user. The overlaying step involves selecting an overlaying proportion indicating a proportion of the voice of the user as unprocessed by the voice transformation model to be laid over a version of the voice of the user as transformed into the voice of another person by the voice transformation model. The producing step involves producing a voice in which the voice of the user is laid over the voice of another person based on the overlaying proportion.

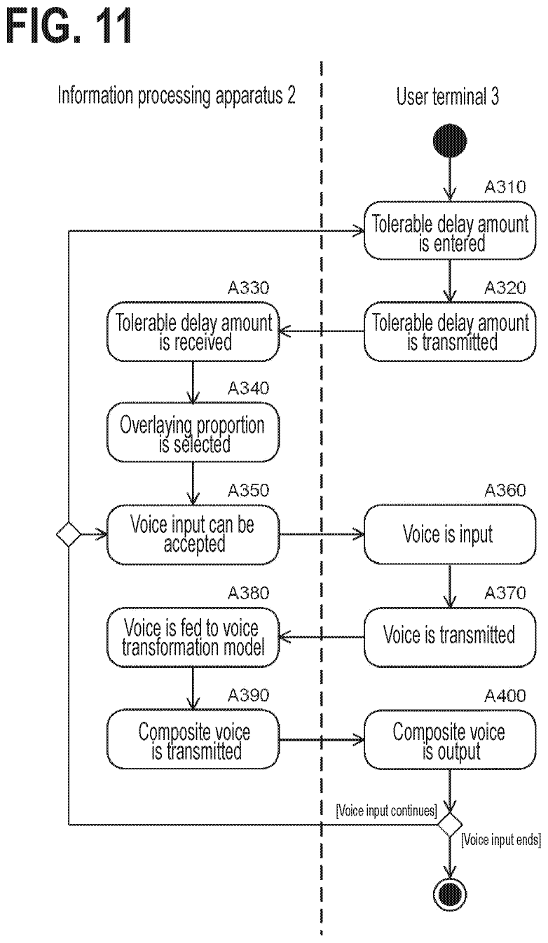

FIG. 11 is an activity diagram of the flow of the second information processing method. The second information processing method will be described below along the activities in the activity diagram.

Firstly, the speech intelligibility level and/or the tolerable amount of delay time (or the tolerable delay time) may be entered by a user through the user terminal 3 (at activity A310). The user terminal 3 may transmit the entered tolerable delay time and/or speech intelligibility level to the information processing apparatus 2 (at activity A 320). The information processing apparatus 2 may receive the tolerable delay time and/or speech intelligibility level from the user terminal 3 (at activity A330). Subsequently, the information processing apparatus 2 may set the overlaying proportion based on the entered tolerable delay time and/or speech intelligibility level (at activity A340).

After the setting of the overlaying proportion, the information processing apparatus 2 may accept from the user terminal 3 the input of the voice of the user (at activity A350). Once the information processing apparatus 2 becomes ready to accept the input of the voice, the voice of the user may be entered through the user terminal 3 (at activity A360). The user terminal 3 may transmit the entered voice to the information processing apparatus 2 as needed (at activity A370). The information processing apparatus 2 may feed the voice of the user transmitted from the user terminal 3 to a voice transformation model associated with the one registered voice that has been set (at activity A380). Further, the information processing apparatus 2 may transmit to the user terminal 3 a voice (or composite voice) in which the processed voice and/or raw voice (or the second voice) is/are laid over the voice of another person that is produced from the voice transformation model (or the first voice) at the overlaying proportion (at activity A390). The user terminal 3 may receive the composite voice from the information processing apparatus 2 and cause the same to be output as audio (at activity A400).

The information processing apparatus 2 may repeat the activities between the acceptance of the voice input (at activity A350) and the transmission of the voice of another person (at activity A390), as long as the user continues to enter the voice. Additionally or alternatively, the information processing apparatus 2 may accept the input of the tolerable delay amount and/or speech intelligibility level while the voice of the user is being entered. Upon the receipt of a different tolerable delay amount and/or speech intelligibility level while the voice is being entered, a different overlaying proportion may be immediately selected in the selecting of the overlaying proportion at activity A340, thereby changing the overlaying proportion for the composite voice being output from the user terminal 3 to a different overlaying proportion in real time.

Effects and advantages of the embodiments disclosed herein will be summarized below. That is, an improvement of usability is provided to a user who wants the input voice of a user to be transformed into the voice of another person.

While embodiments of the present disclosure have been described thus far, these embodiments represent non-limiting embodiments of the present disclosure and can therefore be modified as appropriate to the extent that such modifications do not constitute deviation from the technical ideas of the present disclosure.

While various storage and control are handled by the information processing apparatus 2 in the preceding embodiments, more than one external entity may be used instead of the information processing apparatus 2 to handle such storage and control. That is, various information and programs may be stored in a distributed manner among the more than one external entity, in particular, with the use of a blockchain technology.

The information processing system 1 represents merely one of the non-limiting aspects of the embodiments disclosed herein, including an information processing method and a program. The information processing method includes different steps that may be performed by the information processing apparatus 2. The program causes a computer to function as the information processing apparatus 2.

The information processing system 1 may include an integrated unit of the information processing apparatus 2 and user terminal 3. Thus, the impression information, the tolerable delay amount, voice, and/or other inputs may be entered by a user at the information processing apparatus 2, and the voice transform (or composite voice) processing may be handled by the user terminal 3.

The information processing system 1 may have the following configuration; that is, the information processing system 1 may include a memory and a processor. The memory stores a program. The processor is configured to execute the program to cause the processor to implement an acceptance module configured to accept specification information specifying a voice of another person as desired by a user and a pitch of a voice of the user. The program also causes the processor to implement a setting module configured to set, from among two or more previously prepared and registered voices, one registered voice meeting the specification information and the pitch of the voice of the user, as the voice of another person. In this configuration, the voice of a user can be transformed into the voice of another person that is adapted to the pitch of the user. It should be recognized that the impression information is not necessarily required by the information processing system 1 to set the one registered voice. Also, it is not necessarily required for the information processing system 1 to perform the overlaying of the first and second voices.

The following implementations may be provided.

An information processing system for transforming a voice of a user to a voice of another person different from the user may include a memory and a processor. The memory may store a program. The processor may be configured to execute the program to cause the processor to carry out accepting impression information representing an impression of the voice of another person as desired by the user. The program may also cause the processor to carry out setting, from among two or more previously prepared and registered voices, one registered voice meeting the impression information, as the voice of another person.

In this implementation, the voice of a user can be transformed into a voice that approximates the image (or impression) held by the user.

The setting may set, as the voice of another person, one registered voice assigned with an identifier that is identical or substantially identical to numerical information derived from the impression information.

In this implementation, identifiers can be used to facilitate the registration and management of registered voices.

The setting may include acquiring the numerical information by vectorizing the impression information through natural language processing.

In this implementation, a registered voice that approximates the image held by a user can be picked based on the entered qualitative impression information.

The program may further cause the processor to carry out feeding the voice of the user and the identifier of the one registered voice that is set as the voice of another person to a voice transformation model and producing a version of the voice of the user as transformed into the one registered voice from the voice transformation model. The voice transformation model may include a model that is trained through machine learning to learn a per-identifier relationship between a fed voice and a registered voice.

In this implementation, an input voice can be correctly transformed into the voice of another person based on the impression information from the user.

The voice transformation model may include a plurality of encoders each associated with a respective one of the two or more registered voices and a plurality of decoders each associated with a respective one of the two or more registered voices. The encoders may be configured to receive data on the voice of the user and produce an intermediate feature. The decoders may be configured to receive the intermediate feature and produce data on the version of the voice of the user as transformed into the one registered voice. The producing may include selecting, based on the identifier, one of the encoders to receive the data on the voice of the user and one of the decoders to produce the intermediate feature.

In this implementation, based on impression information entered by a user, an encoder and a decoder can both be selected from among all those encoders and decoders that are prepared for different registered voices, thereby achieving an improved precision with which to transform the voice of a user into the voice of another person.

The accepting may accept specification information specifying the voice of another person and different from the impression information. The setting may set, as the voice of another person, one registered voice assigned with an identifier that is identical or substantially identical to the specification information.

In this implementation, a user can be provided with various ways to specify a voice into which the voice of the user is to be transformed.

The accepting may further accept a pitch of the voice of the user. The setting may set, from among the two or more registered voices, one registered voice meeting the impression information and the pitch of the voice of the user, as the voice of another person.

In this implementation, the voice of a user can be transformed into the voice of another person that is adapted to the pitch of the user.

The information processing system may further include at least one of a computer or an audio interface.

According to this implementation, the information processing system can incorporate a computer or an audio interface as one of many constituent elements or components.

An information processing system for transforming a voice of a user to a voice of another person different from the user may include a memory and a processor. The memory may store a program. The processor may be configured to execute the program to cause the processor to carry out selecting an overlaying proportion indicating a proportion of the voice of the user as unprocessed by a voice transformation model to be laid over a version of the voice of the user as transformed into the voice of another person by the voice transformation model. The program may also cause the processor to carry out producing a voice in which the voice of the user is laid over the voice of another person based on the overlaying proportion.

In this implementation, the delay of output audio due to the processing time at the voice transformation model can be alleviated, and phonemes in the output audio can be made clearer.

The program may further cause the processor to carry out subjecting the voice of the user to signal processing that produces a converted voice of the user. The selecting may select, as the overlaying proportion, an overlaying proportion indicating a proportion of the converted voice of the user from the signal processing to be laid over the voice of another person. The producing may produce a voice in which the converted voice of the user from the signal processing is laid over the voice of another person based on the overlaying proportion.

In this implementation, the voice of a user can be transformed while minimizing possible delay of output audio that is fed back to the user.

The selecting may select, as the overlaying proportion, an overlaying proportion indicating the voice of the user to be laid over the voice of another person. The producing may produce a voice in which the voice of the user is laid over the voice of another person based on the overlaying proportion.

In this implementation, the voice of a user can be transformed while minimizing possible delay of output audio that is fed back to the user.

The accepting may accept a tolerable amount of delay time of a voice to be produced by the producing relative to input of the voice of the user. The selecting may select the overlaying proportion based on the tolerable amount.

In this implementation, the overlaying proportion can be set according to the tolerable amount of the delay that a user prefers.

The selecting may increase the overlaying proportion as the tolerable amount decreases.

In this implementation, the proportion of a version of the voice of a user as transformed by the voice transformation model can be adjusted according to the tolerable amount.

The producing may produce the voice in which the voice of the user is laid over the voice of another person, in a manner perceivable to the user.

In this implementation, audio can be fed back to a user with a minimal delay.

The selecting may select the overlaying proportion in such a way that the voice of the user as unprocessed by the voice transformation model is laid over the voice of another person at a phonation onset phase of the voice of the user.

In this implementation, phonemes in a transformed version of the voice of a user at a phonation onset phase can be made clearer.

The program may further cause the processor to carry out subjecting the voice of the user to signal processing that produces a converted voice of the user. The selecting may select the overlaying proportion in such a way that the converted voice of the user from the signal processing is laid over the voice of another person at the phonation onset phase. The producing may produce a voice in which the converted voice of the user from the signal processing is laid over the voice of another person at a phonation onset phase of the voice of another person.

In this implementation, a segment with such an overlay will sound less awkward, and phonemes in a transformed version of the voice of a user at a phonation onset phase can be made clearer at the same time.

The program may further cause the processor to carry out: accepting specification information specifying the voice of another person as desired by the user and a pitch of the voice of the user; and setting, from among two or more previously prepared and registered voices, one registered voice meeting the specification information and the pitch of the voice of the user, as the voice of another person.

In this implementation, the voice of a user can be transformed into the voice of another person that is adapted to the pitch of the user.

The information processing system may further include at least one of a computer or an audio interface.

According to this implementation, the information processing system can incorporate a computer or an audio interface as one of many constituent elements or components.

An information processing method for transforming a voice of a user to a voice of another person different from the user may include accepting impression information representing an impression of the voice of another person as desired by the user. The method may also include setting, from among two or more previously prepared and registered voices, one registered voice meeting the impression information, as the voice of another person.

It is worthwhile to note that a storage medium storing a control program represented by software for realizing the present disclosure can be loaded into the parameter selection apparatus or an associated memory to produce similar advantages according to the present disclosure. In that case, the program code read from the storage medium implements a set of novel functions of the present disclosure, and the non-transitory, computer-readable storage medium storing the program code forms one aspect of the present disclosure. In some examples, the program code may also be conveyed on a propagation medium. In that case, the program code itself forms another aspect of the present disclosure. It should be noted that examples of the storage medium that can be adopted in these situations include a ROM, a diskette, a hard disk, an optical disk, a magneto-optical disk, a CD-ROM, a CD-R, a magnetic tape, and a non-volatile memory card. Examples of the non-transitory, computer-readable storage medium can even encompass those entities that retain the program for some duration of time, such as volatile memories (for example, a DRAM (or Dynamic Random Access Memory) within a computer system that serves as a server and/or client used to transmit the program over a network such as the Internet and/or a communication line such as a telephone line.

While embodiments of the present disclosure have been described, the embodiments are intended as illustrative only and are not intended to limit the scope of the present disclosure. It will be understood that the present disclosure can be embodied in other forms without departing from the scope of the present disclosure, and that other omissions, substitutions, additions, and/or alterations can be made to the embodiments. Thus, these embodiments and modifications thereof are intended to be encompassed by the scope of the present disclosure. The scope of the present disclosure accordingly is to be defined as set forth in the appended claims.

What is claimed is:

1. An information processing system for transforming a voice of a user to a voice of another person different from the user, the system comprising:
a memory storing a program; and
a processor configured to execute the program to cause the processor to carry out:
accepting impression information representing an impression of the voice of another person as desired by the user; and
setting, from among two or more previously prepared and registered voices, one registered voice meeting the impression information, as the voice of another person.

2. The information processing system according to claim 1, wherein the setting sets, as the voice of another person, one registered voice assigned with an identifier that is identical or substantially identical to numerical information derived from the impression information.

3. The information processing system according to claim 2, wherein the setting comprises acquiring the numerical information by vectorizing the impression information through natural language processing.

4. The information processing system according to claim 2, wherein:
the program further causes the processor to carry out feeding the voice of the user and the identifier of the one registered voice that is set as the voice of another person to a voice transformation model and producing a version of the voice of the user as transformed into the one registered voice from the voice transformation model; and
the voice transformation model comprises a model that is trained through machine learning to learn a per-identifier relationship between a fed voice and a registered voice.

5. The information processing system according to claim 4, wherein:
the voice transformation model comprises a plurality of encoders each associated with a respective one of the two or more registered voices and a plurality of decoders each associated with a respective one of the two or more registered voices;
the encoders are configured to receive data on the voice of the user and produce an intermediate feature;
the decoders are configured to receive the intermediate feature and produce data on the version of the voice of the user as transformed into the one registered voice; and
the producing comprises selecting, based on the identifier, one of the encoders to receive the data on the voice of the user and one of the decoders to receive the intermediate feature.

6. The information processing system according to claim 2, wherein:
the accepting accepts specification information specifying the voice of another person and different from the impression information; and
the setting sets, as the voice of another person, one registered voice assigned with an identifier that is identical or substantially identical to the specification information.

7. The information processing system according to claim 1, wherein:
the accepting further accepts a pitch of the voice of the user; and
the setting sets, from among the two or more registered voices, one registered voice meeting the impression information and the pitch of the voice of the user, as the voice of another person.

8. The information processing system according to claim 1, further comprising at least one of a computer or an audio interface.

9. An information processing system for transforming a voice of a user to a voice of another person different from the user, the system comprising:
a memory storing a program; and
a processor configured to execute the program to cause the processor to carry out:
selecting an overlaying proportion indicating a proportion of the voice of the user as unprocessed by a voice transformation model to be laid over a version of the voice of the user as transformed into the voice of another person by the voice transformation model; and
producing a voice in which the voice of the user is laid over the voice of another person based on the overlaying proportion.

10. The information processing system according to claim 9, wherein:
the program further causes the processor to carry out subjecting the voice of the user to signal processing that produces a converted voice of the user;
the selecting selects, as the overlaying proportion, an overlaying proportion indicating a proportion of the converted voice of the user from the signal processing to be laid over the voice of another person; and
the producing produces a voice in which the converted voice of the user from the signal processing is laid over the voice of another person based on the overlaying proportion.

11. The signal processing system according to claim 9, wherein:
the selecting selects, as the overlaying proportion, an overlaying proportion indicating the voice of the user to be laid over the voice of another person; and
the producing produces a voice in which the voice of the user is laid over the voice of another person based on the overlaying proportion.

12. The information processing system according to claim 10, wherein:
the accepting accepts a tolerable amount of delay time of a voice to be produced by the producing relative to input of the voice of the user; and
the selecting selects the overlaying proportion based on the tolerable amount.

13. The information processing system according to claim 12, wherein the selecting increases the overlaying proportion as the tolerable amount decreases.

14. The information processing system according to claim 9, wherein the producing produces the voice in which the voice of the user is laid over the voice of another person, in a manner perceivable to the user.

15. The information processing system according to claim 9, wherein the selecting selects the overlaying proportion in such a way that the voice of the user as unprocessed by the voice transformation model is laid over the voice of another person at a phonation onset phase of the voice of the user.

16. The information processing system according to claim 15, wherein:
the program further causes the processor to carry out subjecting the voice of the user to signal processing that produces a converted voice of the user;
the selecting selects the overlaying proportion in such a way that the converted voice of the user from the signal processing is laid over the voice of another person at the phonation onset phase; and
the producing produces a voice in which the converted voice of the user from the signal processing is laid over the voice of another person at a phonation onset phase of the voice of another person.

17. The information processing system according to claim 9, wherein the program further causes the processor to carry out accepting specification information specifying the voice of another person as desired by the user and a pitch of the voice of the user, and setting, from among two or more previously prepared and registered voices, one registered voice meeting the specification information and the pitch of the voice of the user, as the voice of another person.

18. The information processing system according to claim 9, further comprising at least one of a computer or an audio interface.

19. An information processing method for transforming a voice of a user to a voice of another person different from the user, the method comprising:
accepting impression information representing an impression of the voice of another person as desired by the user; and
setting, from among two or more previously prepared and registered voices, one registered voice meeting the impression information, as the voice of another person.
